(19) United States
(12) Patent Application Publication
(10) Pub. No.: US 2012/0014109 A1
(43) Pub. Date: Jan. 19, 2012

(54) SMALL FORM FACTOR DURABLE STREET LAMP AND METHOD

(75) Inventor: FREDERICK M. ESPIAU, Topanga, CA (US)

(73) Assignee: Topanga Technologies, Inc., Canoga, CA (US)

(21) Appl. No.: 12/720,619

(22) Filed: Mar. 9, 2010

Related U.S. Application Data
(60) Provisional application No. 61/158,618, filed on Mar. 9, 2009.

(51) Int. Cl. F21V 7/22; F21V 7/00

(52) U.S. Cl. 362/296.04; 362/296.01

(57) ABSTRACT

A shock resistant outdoor lamp. The lamp has a housing having an inner region and an outer region. The lamp also has a reflector provided within a portion of the inner region. The lamp has a bulb assembly coupled to an rf power source coupled to an AC source. The bulb assembly has a base member, including an outer region capable of being coupled to first AC potential and an inner region capable of being coupled to a second AC potential. The bulb assembly also has a support body coupled to the base member. A shock resistant gas filled vessel is included. The vessel has a transparent or translucent body having an inner surface and an outer surface and a cavity formed within the inner surface. The gas filled vessel comprises a first end region and a second end region. The bulb assembly has a length provided between the first end region and the second end region. The bulb assembly has a length provided between nth first end region and the second end region and ranging from about 0.5 centimeter to about three centimeters characterizing the gas filled vessel. The bulb assembly has a thickness of at least about 1 millimeter characterizing a distance between the inner surface and the outer source of the transparent or translucent body and at least one or more coupling members operably coupled to the gas filled vessel such that the outer surface of the gas filled vessel is substantially free from mechanical damage caused with the one or more coupling members and substantially free from any openings in the thickness. The lamp also has a supporting member coupled to the housing, the supporting member configured to a vertical height of greater than fifteen feet.

### CROSS-REFERENCES TO RELATED APPLICATIONS

This application claims priority to U.S. Provisional Application No. 61/158,6181, filed on Mar. 9, 2009, commonly assigned, and incorporated by reference herein for all purpose. This application is also related to U.S. patent application Ser. No. 12/484,933 (Attorney Docket No. 027562-00011US), filed on Jun. 15, 2009 and PCT Application Serial No. PCT/US2009/048171, filed on Jun. 22, 2009, commonly assigned, and incorporated by reference herein for all purpose.

### BACKGROUND OF THE INVENTION

The present invention relates generally to lighting techniques. More particularly, the present invention provides a method and device using a plasma lighting device having a small form factor and durability for indoor and more preferably street lamp applications in high crime rate regions or other regions that lead to breakage or damage of convention street lamps. Merely by way of example, the street lamp applications can include various configurations for parking lots, buildings, stadiums, fields, industrial regions, parks, beaches or water ways, and others.

From the early days, human beings have used a variety of techniques for lighting. Early humans relied on fire to light caves during hours of darkness. Fire often consumed wood for fuel. Wood fuel was soon replaced by candles, which were derived from oils and fats. Candles were then replaced, at least in part by lamps. Certain lamps were fueled by oil or other sources of energy. Gas lamps were popular and still remain important for outdoor activities such as camping. In the late 1800, Thomas Edison, who is one of the greatest inventor of all time, conceived the incandescent lamp, which uses a tungsten filament within a bulb, coupled to a pair of electrodes. Many conventional buildings and homes still use the incandescent lamp, commonly called the Edison bulb. Although highly successful, the Edison bulb consumed much energy and was generally inefficient.

Fluorescent lighting replaced incandescent lamps for certain applications. Fluorescent lamps generally consist of a tube containing a gaseous material, which is coupled to a pair of electrodes. The electrodes are coupled to an electronic ballast, which helps ignite the discharge from the fluorescent lighting. Conventional building structures often use fluorescent lighting, rather than the incandescent counterpart. Fluorescent lighting is much more efficient than incandescent lighting, but often has a higher initial cost.

Conventional lighting and more particularly sodium lamps have been used for outdoor lighting applications. Such outdoor applications include parking lots, streets, stadiums, buildings, and others. Although highly successful, street lamps and in particular sodium lamps are often prone to breakage and damage from mechanical shock. Such mechanical shock may be derived from an automobile crashing into a lamp post or multiple types of vandalism. As an example, street gangs and the like may often damage street lamps using hard objects such as rocks or even bullets shot from a firearm. In certain high crime areas, street lamps are often broken and never replaced since it is difficult to maintain them in working order.

From the above, it is seen that improved techniques for lighting are highly desired.

### BRIEF SUMMARY OF THE INVENTION

According to the present invention, techniques related generally to lighting are provided. More particularly, the present invention provides a method and device using a plasma lighting device having a small form factor and durability for indoor and more preferably street lamp applications in high crime rate regions or other regions that lead to breakage or damage of convention street lamps. Merely by way of example, the street lamp applications can include various configurations for parking lots, buildings, stadiums, fields, industrial regions, parks, beaches or water ways, and others.

In a specific embodiment, the present invention provides a shock resistant outdoor lamp comprising a lamp apparatus, which is capable of withstanding an impact of a bullet or other hard object. In a specific embodiment, the apparatus has a housing having an inner region and an outer region. An inner cavity is formed from the inner region. A reflector is provided within a portion of the inner region. An rf power source is disposed within the inner cavity. In a specific embodiment, the rf power source is coupled to an AC source. In a preferred embodiment, the lamp has a small form factor bulb assembly coupled to the rf power source. The bulb assembly includes a base member, which has an outer region capable of being coupled to first AC potential and an inner region capable of being coupled to a second AC potential. The bulb assembly also has a support body coupled to the base member and a shock resistant gas filled vessel having a transparent or translucent body having an inner surface and an outer surface and a sealed cavity formed within the inner surface. In a preferred embodiment, the gas filled vessel includes a first end region, a second end region, and the length defined between the first end region and the second end region. The small form factor is provided by an overall length ranging from about 3 millimeters to about 15 millimeters characterizing the gas filled vessel and a thickness of at least about 0.5 millimeters to about 2 millimeters characterizing a distance between the inner surface and the outer source of the transparent or translucent body in a specific embodiment. In a specific embodiment, the gas filled vessel can have a diameter ranging from about 1 millimeter to about 15 millimeters, but can be others. Of course, there can also be other dimensions depending upon the specific application. In a specific embodiment, at least one or more coupling members is operably coupled to the gas filled vessel such that the outer surface of the gas filled vessel is substantially free from mechanical damage caused with the one or more coupling members and substantially free from any openings in the thickness. In a preferred embodiment, the apparatus has a transparent cover comprising a polycarbonate material, which is capable of withstanding an impact of bullet from a conventional handgun or rifle, such as calibers ranging from about 22, 38, 45, 44 Magnum, 357 Magnum, and 7 mm, 9 mm, and others, including shot shells and/or pellets. A supporting member is coupled the housing. The supporting member has a vertical height of greater than fifteen feet, but can be others.

In an alternative specific embodiment, the present invention provides a shock resistant outdoor lamp comprising a lamp apparatus, which is capable of withstanding an impact of a bullet or other hard object. In a specific embodiment, the apparatus has a housing having an inner region and an outer region. An inner cavity is formed from the inner region. A reflector is provided within a portion of the inner region. An rf power source is disposed within the cavity. In a specific embodiment, the rf power source is coupled to an AC source. In a preferred embodiment, the lamp has a small form factor bulb assembly coupled to the rf power source. The bulb assembly includes a base member, which has an outer region capable of being coupled to first AC potential and an inner region capable of being coupled to a second AC potential. The bulb assembly also has a support body coupled to the base member and a shock resistant gas filled vessel having a transparent or translucent body having an inner surface and an outer surface and a cavity formed within the inner surface. In a preferred embodiment, the gas filled vessel includes a first end region, a second end region, and the length defined between the first end region and the second end region. In a specific embodiment, the small form factor is provided by an overall length ranging from about 3 millimeters to about 15 millimeters characterizing the gas filled vessel and a thickness of at least about 0.5 millimeters to about 2 millimeters characterizing a distance between the inner surface and the outer source of the transparent or translucent body. In a specific embodiment, the gas filled vessel can have a diameter ranging from about 1 millimeter to about 15 millimeters, but can be others. Of course, there can also be other dimensions depending upon the specific application. In a specific embodiment, at least one or more coupling members is operably coupled to the gas filled vessel such that the outer surface of the gas filled vessel is substantially free from mechanical damage caused with the one or more coupling members and substantially free from any openings in the thickness.

Benefits are achieved over pre-existing techniques using the present invention. In a specific embodiment, the present invention provides a method and apparatus using a small form factor electroless bulb for a street lamp application requiring shock or impact resistance. In a preferred embodiment, the present invention provides a method and configurations with an arrangement that provides for improved manufacturability as well as design flexibility. Other embodiments may include a substantially impact resistant cover, which would also help make the present apparatus shock proof or generally shatterproof upon impact with certain objects. In a preferred embodiment, the present apparatus can be used in a geographic area having high rates of vandalism without compromising the present apparatus. In a specific embodiment, the present apparatus and bullet proof fixture can also lead to lower crime rates. In a preferred embodiment, the bulb is substantially free from internal electrodes and/or external mechanical stress that leads to breakage and the like. Depending upon the embodiment, one or more of these benefits may be achieved. These and other benefits may be described throughout the present specification and more particularly below.

The present invention achieves these benefits and others in the context of known process technology. However, a further understanding of the nature and advantages of the present invention may be realized by reference to the latter portions of the specification and attached drawings.

### BRIEF DESCRIPTION OF THE DRAWINGS

FIG. 1 is a simplified diagram of a conventional street lamp according to an embodiment of the present invention;

FIG. 2 is a simplified diagram of a street lamp according to an embodiment of the present invention;

FIG. 3 is a simplified diagram of a conventional street lamp housing for a cobra head design;

FIG. 4 is a simplified diagram of a street lamp housing for a cobra head design according to an embodiment of the present invention;

FIG. 4A is a simplified perspective diagram of the street lamp housing for the cobra head design according to an embodiment of the present invention; and

FIG. 5 is a simplified diagram of a relationship between impact and chronic failure for conventional and present lamp according to an embodiment of the present invention.

### DETAILED DESCRIPTION OF THE INVENTION

According to the present invention, techniques related generally to lighting are provided. More particularly, the present invention provides a method and device using a plasma lighting device having a small form factor and durability for indoor and more preferably street lamp applications in high crime rate regions or other regions that lead to breakage or damage of convention street lamps. Merely by way for parking lots, buildings, stadiums, fields, industrial regions, parks, beaches or water ways, and others.

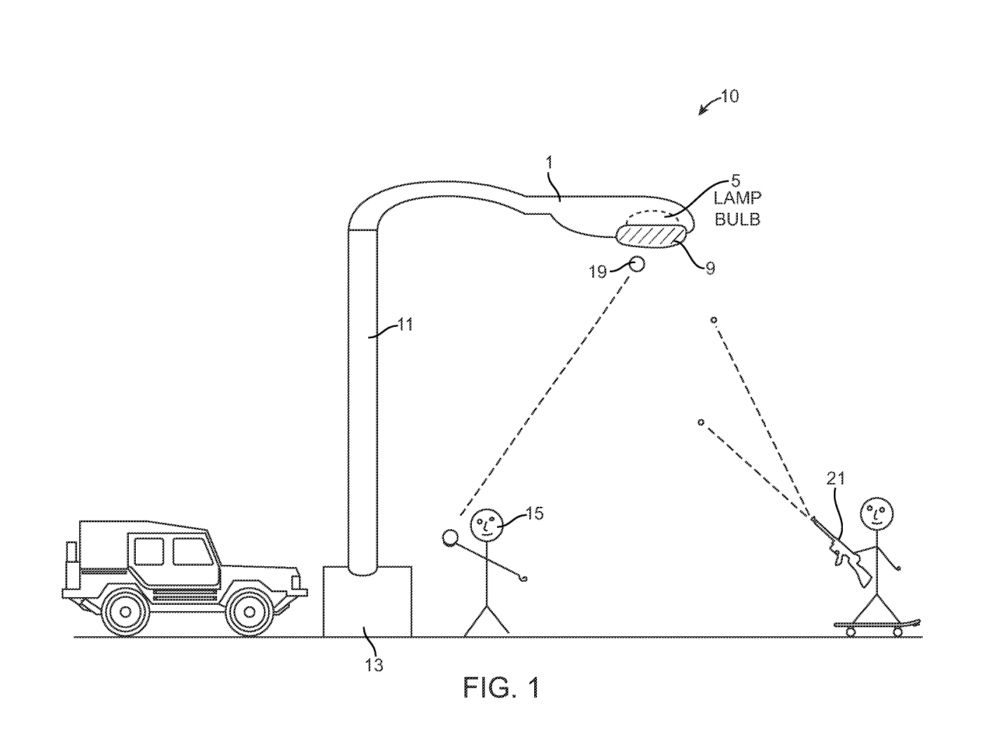

FIG. 1 is a simplified diagram of a conventional street lamp according to an embodiment of the present invention. As shown, the conventional street lamp 10 has a large head structure 1, which includes a large incandescent lamp 9. The large incandescent lamp is often sodium based or other conventional material. As shown, the large lamp occupies a large spatial region of the head structure and serves as an easy target for vandals. The large lamp often has a length of six inches and a width of about three inches, which, again, serves as a large target for a vandal. The large incandescent lamp is often fragile and prone to breakage upon impact. The head structure generally includes a plate 9 covering the lamp 10. The plate is also made of a fragile material such as glass or plastic material, which can fracture upon impact. The head is mounted to a pole 111 coupled to a base 13 that is secured to a ground or other building structure.

As shown, the lamp and plate are often prone to damage or breakage. That is, hard objects such as a rock 19 or ball impacts the plate, which can often break and/or cause damage to the lamp. As shown, vandals 15 often throw rocks or shoot out the plate and lamp. A firearm 21 is often a choice apparatus for shooting, although there can be others. In city areas with high crime rates, street lamps are often broken from vandalism causing even higher rates of crime and other socially undesirable activities. Additionally, in certain suburban or country areas, street lamps are also damaged from vandalism leading to more vandalism and other undesirable activities. These and other limitations with conventional street lamps have been overcome by way of the present street lamp and related methods, which have been described throughout the present specification and more particularly below.

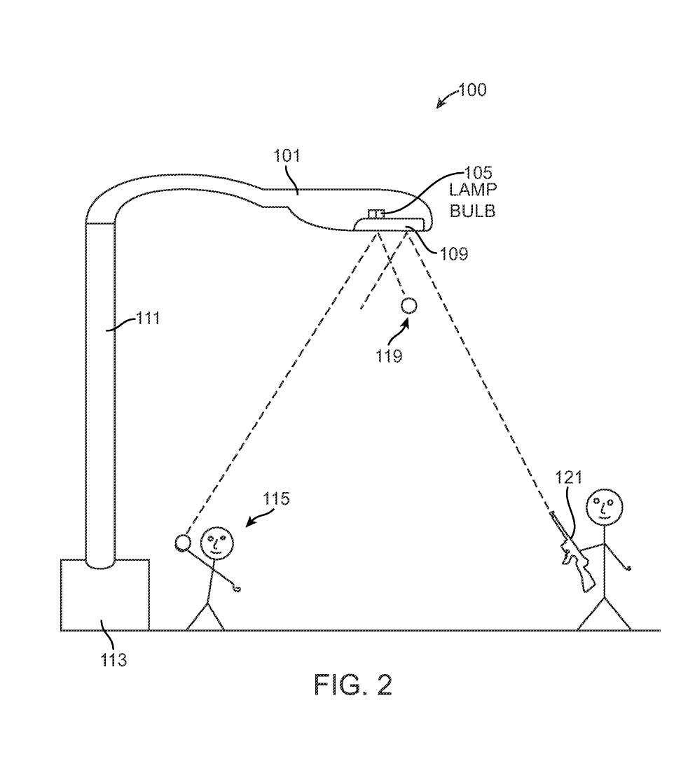

FIG. 2 is a simplified diagram of a street lamp according to an embodiment of the present invention This diagram is merely an example, which should not unduly limit the scope of the claims herein. One of ordinary skill in the art would recognize other variations, modifications, and alternatives. As shown, the present street lamp 100 has a head structure 110, which includes a small form factor electroless lamp 109. In a specific embodiment, the small form factor lamp is often an electroless lamp such as those described in U.S. patent application Ser. No. 12/484,933 (Attorney Docket No. 027562-00011US), filed on Jun. 15, 2009 and PCT Application Serial No. PCT/US2009/048171, filed on Jun. 22, 2009, commonly assigned, and hereby incorporated by reference. Alternatively, such lamp can be described in U.S. Pat. No. 6,737,809, among others, which are incorporated by reference according to a specific embodiment. As shown, the lamp occupies a small spatial region of the head structure. The small form factor is provided by an overall length ranging from about 3 millimeters to about 15 millimeters characterizing the gas filled vessel and a thickness of at least about 0.5 millimeters to about 2 millimeters characterizing a distance between the inner surface and the outer source of the transparent or translucent body. In a specific embodiment, the gas filled vessel can have a diameter ranging from about 1 millimeter to about 15 millimeters, but can be others. Of course, there can also be other dimensions depending upon the specific application. In a preferred embodiment, the present lamp is much smaller than conventional sodium based lamp devices. Unlike the conventional lamps, the present small form factor lamp is generally not fragile and not prone to breakage upon impact. Further details of experimental data regarding impact are provided in more detail below.

In a specific embodiment, the head structure also includes a plate 119 covering the lamp 110. In a specific embodiment, the plate is suitable made of a durable material, such as polycarbonate or other like materials. In a specific embodiment, the plate is optically transparent, but has suitable strength upon impact. The plate can be a single layered structure, molded, extruded, or a single homogeneous material, including any combinations and the like. In a specific embodiment, the term “bullet proof” glass is often a type of polycarbonate material that is suitable for the present small form factor apparatus. Further details of the present lamp are provided below.

In a specific embodiment, the head is mounted to a pole 111 coupled to a base 13 that is secured to a ground or other building structure. In a specific embodiment, the pole can be made of a metal material, wood, or plastic, as well as others. In a specific embodiment, the pole has a length of at least about 15 feet or others. In other embodiments, the pole can be replaced by a building structure or a combination of a mounting member and the building structure. The building structure can be a house, commercial building, bill board, stadium, tree, pole, bridge, street, or others. Of course, there can be other variations, modifications, and alternatives.

As shown, the present lamp and plate are often not prone to damage or breakage. That is, hard objects such as a rock 119 or ball impacts the plate, which remains intact and does not break and/or cause damage to the lamp. As shown, vandals 115 would attempt to throw rocks or shoot out the plate and lamp, but will be generally unsuccessful. A firearm 121 is often a choice apparatus for shooting, although there can be others. In city areas with high crime rates, street lamps would not be broken from certain types vandalism and remain working and intact. Additionally, in certain suburban or country areas, street lamps would also not be damaged from certain types of vandalism leading to more vandalism and other undesirable activities. Further details of the present street lamp can be found throughout the present specification and more particularly below.

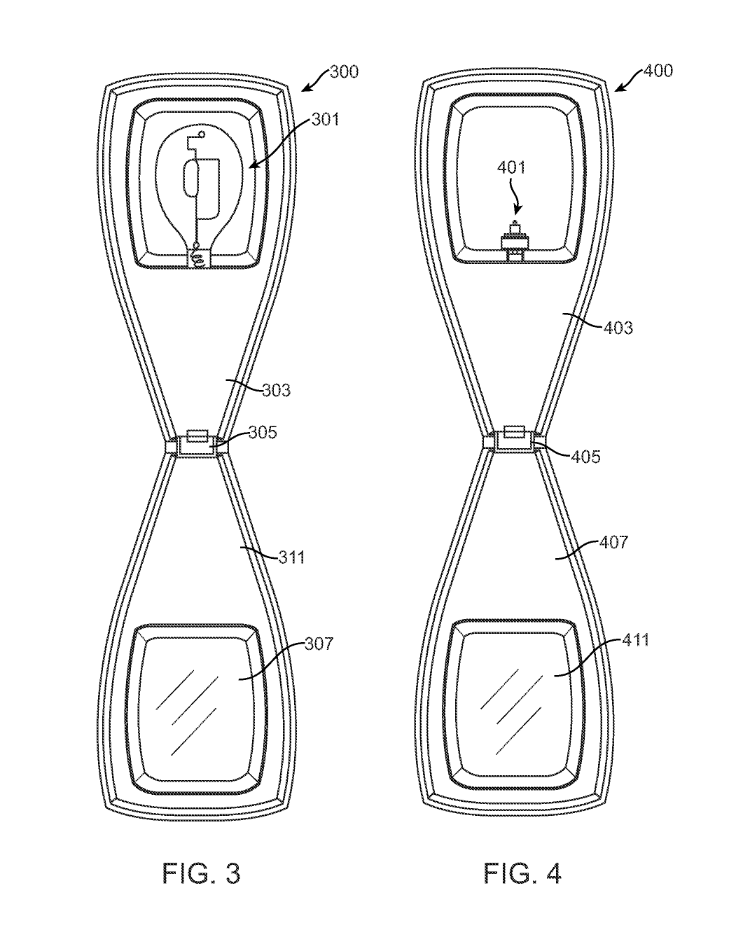

FIG. 3 is a simplified diagram of a conventional housing 300 for a cobra head lamp design. The cobra head lamp design is often used in street lighting, and has been used for many years. The cobra head design is shaped like a “cobra head” and is configured with a hinge 305 operably coupling an upper housing 303 and a lower housing 311 in a clam shell configuration, as shown. The upper housing includes a reflector region having a large sodium vapor lamp 301, as an example. The large lamp occupies at least fifty to eighty percent of a total region of the lens coupled to the upper housing. The conventional lamp often has a length of about eight inches and a width of three inches, which are good targets for vandalism and the like. The lower housing often includes a glass 307 lens or like structure, which is fragile upon impact. These and other limitations are overcome, at least in part, by way of the present lamp structure and related methods, which are described in more detail below.

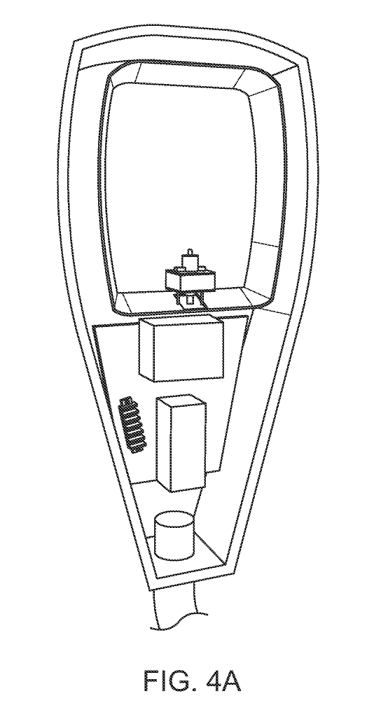

FIG. 4 is a simplified diagram of a street lamp housing 400 for a cobra head design according to an embodiment of the present invention. This diagram is merely an example, which should not unduly limit the scope of the claims herein. One of ordinary skill in the art would recognize other variations, modifications, and alternatives. In a specific embodiment, the cobra head lamp design can be used with a small form factor lamp. In a specific embodiment, the cobra head design is shaped like a “cobra head” and is configured with a hinge 405 operably coupling an upper housing 403 and a lower housing 407 in a clam shell configuration, as shown. The upper housing includes a reflector region having a small form factor lamp assembly 401, as an example. The small lamp occupies at less than ten percent (or less than five percent) of a total region of the upper housing in a conventional cobra head lamp according to a preferred embodiment. The small form factor is provided by an overall length ranging from about 3 millimeters to about 15 millimeters characterizing the gas filled vessel and a thickness of at least about 0.5 millimeters to about 2 millimeters characterizing a distance between the inner surface and the outer source of the transparent or translucent body. In a specific embodiment, the gas filled vessel can have a diameter ranging from about 1 millimeter to about 15 millimeters, but can be others. Of course, there can also be other dimensions depending upon the specific application. The present lamp often has a length that is much smaller, which is a poor target for vandalism and the like. The lower housing often includes a bullet proof glass 411 lens or like structure, which is generally not fragile upon impact.

In a preferred embodiment, the small form factor lamp is an electroless lamp or the like. The small form factor lamp is often an electroless lamp such as those described in U.S. patent application Ser. No. 12/484,933 (Attorney Docket No. 027562-00011US), filed on Jun. 15, 2009 and PCT Application Serial No. PCT/US2009/048171, filed on Jun. 22, 2009, commonly assigned, and hereby incorporated by reference. Alternatively, such lamp can be described in U.S. Pat. No. 6,737,809, among others, which are incorporated by reference according to a specific embodiment. As shown, the lamp occupies a small spatial region of the head structure. In a specific embodiment, the present lamp often has a length of 10 millimeters and a width of 3 millimeter, which are much smaller than conventional sodium based lamp devices. In a preferred embodiment, the small form factor lamp is generally shock proof since it is free from internal electrodes, has a small form factor, and no external mechanical stress/stain. Unlike the conventional lamps, the present small form factor lamp is generally not fragile and not prone to breakage upon impact.

In a specific embodiment, the head structure also includes a bullet proof plate 411 covering the lamp 401. In a specific embodiment, the plate is suitable made of a durable material, such as polycarbonate or other like materials. In a specific embodiment, the plate is optically transparent, but has suitable strength upon impact. The plate can be a single layered structure, molded, extruded, or a single homogeneous material, including any combinations and the like. In a specific embodiment, the term “bullet proof” glass is often a type of polycarbonate material that is suitable for the present small form factor apparatus. In one or more embodiments, the bullet proof glass is often constructed using a strong but transparent material such as polycarbonate thermoplastic or by using layers of laminated glass. The desired result is a material with an appearance and light-transmitting behavior of standard glass but offers varying degrees of protection from small arms fire. See, for example, http://en.wikipedia.org/wiki/Bulletproof_glass#Recent_advances_in_bullet-resistant_{—}glass_composition. Of course, there can be other variations, modifications, and alternatives.

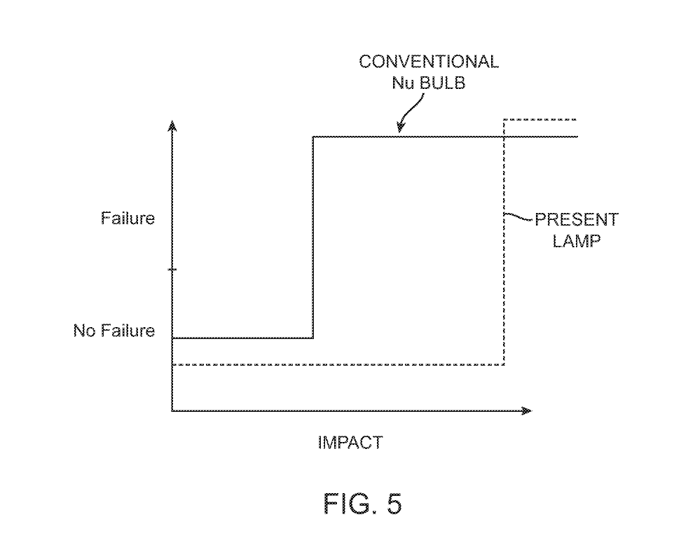

FIG. 5 is a simplified diagram of a relationship between impact and chronic failure for conventional and present lamp according to an embodiment of the present invention. This diagram is merely an example, which should not unduly limit the scope of the claims herein.

One of ordinary skill in the art would recognize other variations, modifications, and alternatives. As shown, failure is provided on the vertical axis, while impact is on the horizontal axis. As can be seen, failure for the conventional lamp occurs at a selected region, which is often from impact of hard objects, bullets, or other things. Failure for the present lamp occurs at a much higher impact or may not occur at all. Indications for impacts from bullets fired from a 22 caliber rifle, 12 gauge shot gun, automobiles, and rocks are also illustrated. Of course, there can be other variations, modifications, and alternatives.

While the above is a full description of the specific embodiments, various modifications, alternative constructions and equivalents may be used. Therefore, the above description and illustrations should not be taken as limiting the scope of the present invention which is defined by the appended claims.

1. A shock resistant outdoor lamp comprising a lamp apparatus, the lamp apparatus comprising:
a housing having an inner region and an outer region, an inner cavity formed from the inner region;
a reflector provided within a portion of the inner region;
an rf power source disposed within the inner cavity, the rf power source being coupled to an AC source;
a bulb assembly coupled to the rf power source, the bulb assembly comprising:
a base member, the base member having an outer region capable of being coupled to first AC potential and an inner region capable of being coupled to a second AC potential;
a support body coupled to the base member;
a shock resistant gas filled vessel having a transparent or translucent body having an inner surface and an outer surface and a sealed cavity formed within the inner surface, the gas filled vessel comprising a first end region and a second end region;
a length provided between the first end region and the second end region and ranging from about 1 millimeter to about 15 millimeters to characterize the gas filled vessel;
a thickness of at least about 0.5 millimeters characterizing a distance between the inner surface and the outer source of the transparent or translucent body;
at least one or more coupling members operably coupled to the gas filled vessel such that the outer surface of the gas filled vessel is substantially free from mechanical damage caused with the one or more coupling members and substantially free from any openings in the thickness;
a transparent cover comprising a polycarbonate material, the transparent cover being capable of withstanding an impact of a bullet fired from a firearm having a caliber of 22 caliber and greater or one or more shots fired from a shot gun of at least 12 gauge; and
a supporting member coupled the housing, the supporting member having a vertical height of greater than fifteen feet.

2. The lamp apparatus of claim 1 wherein the transparent cover is shock resistant.

3. The lamp apparatus of claim 1 wherein the gas filled vessel is about less than 10 percent in spatial size as compared to a conventional sodium lamp bulb.

4. The lamp apparatus of claim 1 wherein the shock resistant gas filled vessel comprises the transparent or translucent body characterized by a continuous thickness of material to define the sealed cavity.

5. The lamp apparatus of claim 1 wherein the sealed cavity comprises argon.

6. The lamp apparatus of claim 1 wherein the transparent cover is a bullet proof material including polycarbonate.

7. The lamp apparatus of claim 1 wherein the reflector comprises one or more portions partially enclosing the bulb assembly.

8. The lamp apparatus of claim 1 wherein the reflector is made of a metal material.

9. The lamp apparatus of claim 1 wherein the bulb assembly is substantially shock proof, the bulb assembly comprising the shock proof gas filled bulb being free from one or more internal electrodes and being substantially free from any external mechanical stress or strain.

10. The lamp apparatus of claim 1 wherein the bulb assembly is substantially shock proof, the bulb assembly comprising the shock proof gas filled bulb being free from one or more internal electrodes.

11. The lamp apparatus of claim 1 wherein the lamp apparatus is geographically disposed in a high crime rate area, the high crime rate area having at least 1 incident per month.

12. A shock resistant outdoor lamp comprising a lamp apparatus, the lamp apparatus comprising:
a housing having an inner region and an outer region, an inner cavity formed from the inner region;
a reflector provided within a portion of the inner region;
an rf power source disposed within the cavity, the rf power source being coupled to an AC source;
a bulb assembly coupled to the rf power source, the bulb assembly comprising:
a base member, the base member having an outer region capable of being coupled to first AC potential and an inner region capable of being coupled to a second AC potential;
a support body coupled to the base member;
a shock resistant gas filled vessel having a transparent or translucent body having an inner surface and an outer surface and a cavity formed within the inner surface, the gas filled vessel comprising a first end region, a second end region, and the length defined between the first end region and the second end region; the length ranging from about 3 millimeters to about 15 millimeters characterizing the gas filled vessel;
a thickness of at least about 0.5 millimeter characterizing a distance between the inner surface and the outer source of the transparent or translucent body;
at least one or more coupling members operably coupled to the gas filled vessel such that the outer surface of the gas filled vessel is substantially free from mechanical damage caused with the one or more coupling members and substantially free from any openings in the thickness; and
a supporting member coupled the housing, the supporting member having a vertical height of greater than fifteen feet.

13. The lamp apparatus of claim 12 further comprising a transparent cover comprising a polycarbonate material, the transparent cover being capable of withstanding an impact of a bullet from at least a 22 caliber gun and greater.

14. The lamp apparatus of claim 13 wherein the transparent cover is shock resistant; wherein the gas filled vessel is less than about 10 percent in spatial size as compared to a conventional sodium lamp bulb; wherein the shock resistant gas filled vessel comprises the transparent or translucent body characterized by a continuous thickness of material to define the cavity.

15-16. (canceled)

17. The lamp apparatus of claim 12 wherein the cavity comprises argon.

18. The lamp apparatus of claim 13 wherein the transparent cover is a material known as Plexiglas™.

19. The lamp apparatus of claim 12 wherein the reflector comprises one or more portions partially enclosing the bulb assembly, wherein the reflector is made of a metal material.

20. (canceled)

21. The lamp apparatus of claim 12 wherein the bulb assembly is substantially shock proof, the bulb assembly comprising the shock proof gas filled bulb being free from one or more internal electrodes.

22. The lamp apparatus of claim 12 wherein the bulb assembly is substantially shock proof, the bulb assembly comprising the shock proof gas filled bulb being free from one or more internal electrodes and being substantially free from any external mechanical stress or strain.

23. A shock resistant outdoor lamp comprising a lamp apparatus, the lamp apparatus comprising:
a housing having an inner region and an outer region, an inner cavity formed from the inner region;
a reflector provided within a portion of the inner region;
a bulb assembly coupled to an rf power source coupled to an AC source, the bulb assembly comprising:
a base member, the base member having an outer region capable of being coupled to first AC potential and an inner region capable of being coupled to a second AC potential;
a support body coupled to the base member;
a shock resistant gas filled vessel having a transparent or translucent body having an inner surface and an outer surface and a cavity formed within the inner surface, the gas filled vessel comprising a first end region, a second end region, and the length defined between the first end region and the second end region;
a length ranging from about 0.5 centimeter to about three centimeters characterizing the gas filled vessel;
a thickness of at least about 1 millimeter characterizing a distance between the inner surface and the outer source of the transparent or translucent body;
at least one or more coupling members operably coupled to the gas filled vessel such that the outer surface of the gas filled vessel is substantially free from mechanical damage caused with the one or more coupling members and substantially free from any openings in the thickness; and
a supporting member coupled the housing, the supporting member configured to a vertical height of greater than fifteen feet.
